(19) United States
(12) Patent Application Publication
(10) Pub. No.: US 2008/0024429 A1
(43) Pub. Date: Jan. 31, 2008

(54) ELECTROPHORETIC DISPLAYS USING GASEOUS FLUIDS

(75) Inventor: Robert W. Zehner, Belmont, MA (US)

Correspondence Address: DAVID J COLE;E INK CORPORATION, 733 CONCORD AVE, CAMBRIDGE, MA, 02138-1002, US

(73) Assignee: E INK CORPORATION, Cambridge, MA (US)

(21) Appl. No.: 11/781,373

(22) Filed: Jul. 23, 2007

Related U.S. Application Data
(60) Provisional application No. 60/820,235, filed on Jul. 25, 2006.

(51) Int. Cl. G09G 3/34

(52) U.S. Cl. 345/107

(57) ABSTRACT

An electrophoretic display comprises a pair of facing substrates, at least one of which is transparent, a plurality of particles and a gas between the substrates, and means for applying an electric field to cause the particles to move and thus change the electro-optic state of the display. The electric field means is arranged to increase the impulse applied to the display with increasing time since a reference time, or with increasing number of images written on the display. In another embodiment, an alternating current pulse is applied to the display, and the duration and/or amplitude of the alternating current pulse is increased with increasing time since a reference time.

### REFERENCE TO RELATED APPLICATIONS

This application claims benefit of copending Application Ser. No. 60/820,235, filed Jul. 25, 2006.

This application is related to a series of patents and applications assigned to E Ink Corporation, this series of patents and applications being directed to MEthods for Driving Electro-Optic Displays, and hereinafter collectively referred to as the “MEDEOD” applications. This series of patents and applications comprises:
(a) U.S. Pat. No. 6,504,524;
(b) U.S. Pat. No. 6,531,997;
(c) U.S. Pat. No. 7,012,600;
(d) copending application Ser. No. 11/160,455, filed Jun. 24, 2005 (Publication No. 2005/0219184;
(e) copending application Ser. No. 11/307,886, filed Feb. 27, 2006 (Publication No. 2006/0139310);
(f) copending application Ser. No. 11/307,887, filed Feb. 27, 2006 (Publication No. 2006/0139311);
(g) U.S. Pat. No. 7,193,625;
(h) copending application Ser. No. 11/611,324, filed Dec. 15, 2006 (Publication No. 2007/0091418);
(i) U.S. Pat. No. 7,119,772;
(j) copending application Ser. No. 11/425,408, filed Jun. 21, 2006 (Publication No. 2006/0232531);
(k) copending application Ser. No. 10/879,335, filed Jun. 29, 2004 (Publication No. 2005/0024353);
(l) copending application Ser. No. 10/904,707, filed Nov. 24, 2004 (Publication No. 2005/0179642);
(m) copending application Ser. No. 10/906,985, filed Mar. 15, 2005 (Publication No. 2005/0212747);
(n) copending application Ser. No. 10/907,140, filed Mar. 22, 2005 (Publication No. 2005/0213191);
(o) copending application Ser. No. 11/161,715, filed Aug. 13, 2005 (Publication No. 2005/0280626);
(p) copending application Ser. No. 11/162,188, filed Aug. 31, 2005 (Publication No. 2006/0038772);
(q) U.S. Pat. No. 7,230,751, issued Jun. 12, 2007 on application Ser. No. 11/307,177, filed Jan. 26, 2006, which itself claims benefit of Provisional Application Ser. No. 60/593,570, filed Jan. 26, 2005, and Provisional Application Ser. No. 60/593,674, filed Feb. 4, 2005;
(r) copending application Ser. No. 11/461,084, filed Jul. 31, 2006 (Publication No. 2006/0262060); and
(s) copending application Ser. No. 11/751,879, filed May 22, 2007.

The entire contents of these patents and copending applications, and of all other U.S. patents and published and copending applications mentioned below, are herein incorporated by reference.

### BACKGROUND OF INVENTION

This invention relates to electrophoretic displays using gaseous fluids.

Particle-based electrophoretic displays have been the subject of intense research and development for a number of years. In this type of display, a plurality of charged particles move through a fluid under the influence of an electric field. Electrophoretic displays can have attributes of good brightness and contrast, wide viewing angles, state bistability, and low power consumption when compared with liquid crystal displays. In such electrophoretic displays, an optical property is changed by application of the electric field; this optical property is typically color perceptible to the human eye, but may be another optical property, such as optical transmission, reflectance, luminescence or, in the case of displays intended for machine reading, pseudo-color in the sense of a change in reflectance of electromagnetic wavelengths outside the visible range.

The terms “bistable” and “bistability” are used herein in their conventional meaning in the art to refer to displays comprising display elements having first and second display states differing in at least one optical property, and such that after any given element has been driven, by means of an addressing pulse of finite duration, to assume either its first or second display state, after the addressing pulse has terminated, that state will persist for at least several times, for example at least four times, the minimum duration of the addressing pulse required to change the state of the display element. It is shown in U.S. Pat. No. 7,170,670 that some particle-based electrophoretic displays capable of gray scale are stable not only in their extreme black and white states but also in their intermediate gray states, and the same is true of some other types of electro-optic displays. This type of display is properly called “multi-stable” rather than bistable, although for convenience the term “bistable” may be used herein to cover both bistable and multi-stable displays.

Nevertheless, problems with the long-term image quality of electrophoretic displays have prevented their widespread usage. For example, particles that make up electrophoretic displays tend to settle, resulting in inadequate service-life for these displays.

Numerous patents and applications assigned to or in the names of the Massachusetts Institute of Technology (MIT) and E Ink Corporation have recently been published describing encapsulated electrophoretic media. Such encapsulated media comprise numerous small capsules, each of which itself comprises an internal phase containing electrophoretically-mobile particles suspended in a liquid suspending medium, and a capsule wall surrounding the internal phase. Typically, the capsules are themselves held within a polymeric binder to form a coherent layer positioned between two electrodes. Encapsulated media of this type are described, for example, in U.S. Pat. Nos. 5,930,026; 5,961,804; 6,017,584; 6,067,185; 6,118,426; 6,120,588; 6,120,839; 6,124,851; 6,130,773; 6,130,774; 6,172,798; 6,177,921; 6,232,950; 6,249,271; 6,252,564; 6,262,706; 6,262,833; 6,300,932; 6,312,304; 6,312,971; 6,323,989; 6,327,072; 6,376,828; 6,377,387; 6,392,785; 6,392,786; 6,413,790; 6,422,687; 6,445,374; 6,445,489; 6,459,418; 6,473,072; 6,480,182; 6,498,114; 6,504,524; 6,506,438; 6,512,354; 6,515,649; 6,518,949; 6,521,489; 6,531,997; 6,535,197; 6,538,801; 6,545,291; 6,580,545; 6,639,578; 6,652,075; 6,657,772; 6,664,944; 6,680,725; 6,683,333; 6,704,133; 6,710,540; 6,721,083; 6,724,519; 6,727,881; 6,738,050; 6,750,473; 6,753,999; 6,816,147; 6,819,471; 6,822,782; 6,825,068; 6,825,829; 6,825,970; 6,831,769; 6,839,158; 6,842,167; 6,842,279; 6,842,657; 6,864,875; 6,865,010; 6,866,760; 6,870,661; 6,900,851; 6,922,276; 6,950,200; 6,958,848; 6,967,640; 6,982,178; 6,987,603; 6,995,550; 7,002,728; 7,012,600; 7,012,735; 7,023,420; 7,030,412; 7,030,854; 7,034,783; 7,038,655; 7,061,663; 7,071,913; 7,075,502; 7,075,703; 7,079,305; 7,106,296; 7,109,968; 7,110,163; 7,110,164; 7,116,318; 7,116,466; 7,119,759; 7,119,772; 7,148,128; 7,167,155; 7,170,670; 7,173,752; 7,176,880; 7,180,649; 7,190,008; 7,193,625; 7,202,847; 7,202,991; 7,206,119; 7,223,672; 7,230,750; 7,230,751; 7,236,790; and 7,236,792; and U.S. Patent Applications Publication Nos. 2002/0060321; 2002/0090980; 2003/0011560; 2003/0102858; 2003/0151702; 2003/0222315; 2004/0094422; 2004/0105036; 2004/0112750; 2004/0119681; 2004/0136048; 2004/0155857; 2004/0180476; 2004/0190114; 2004/0196215; 2004/0226820; 2004/0257635; 2004/0263947; 2005/0000813; 2005/0007336; 2005/0012980; 2005/0017944; 2005/0018273; 2005/0024353; 2005/0062714; 2005/0067656; 2005/0099672; 2005/0122284; 2005/0122306; 2005/0122563; 2005/0134554; 2005/0151709; 2005/0152018; 2005/0156340; 2005/0179642; 2005/0190137; 2005/0212747; 2005/0213191; 2005/0219184; 2005/0253777; 2005/0280626; 2006/0007527; 2006/0024437; 2006/0038772; 2006/0139308; 2006/0139310; 2006/0139311; 2006/0176267; 2006/0181492; 2006/0181504; 2006/0194619; 2006/0197736; 2006/0197737; 2006/0197738; 2006/0202949; 2006/0223282; 2006/0232531; 2006/0245038; 2006/0256425; 2006/0262060; 2006/0279527; 2006/0291034; 2007/0035532; 2007/0035808; 2007/0052757; 2007/0057908; 2007/0069247; 2007/0085818; 2007/0091417; 2007/0091418; 2007/0097489; 2007/0109219; 2007/0128352; and 2007/0146310; and International Applications Publication Nos. WO 00/38000; WO 00/36560; WO 00/67110; and WO 01/07961; and European Patents Nos. 1,099,207 B1; and 1,145,072 B1.

Some of the aforementioned patents and published applications disclose encapsulated electrophoretic media having three or more different types of particles within each capsule. For purposes of the present application, such multi-particle media are regarded as sub-species of dual particle media.

Many of the aforementioned patents and applications recognize that the walls surrounding the discrete microcapsules in an encapsulated electrophoretic medium could be replaced by a continuous phase, thus producing a so-called polymer-dispersed electrophoretic display, in which the electrophoretic medium comprises a plurality of discrete droplets of an electrophoretic fluid and a continuous phase of a polymeric material, and that the discrete droplets of electrophoretic fluid within such a polymer-dispersed electrophoretic display may be regarded as capsules or microcapsules even though no discrete capsule membrane is associated with each individual droplet; see for example, the aforementioned U.S. Pat. No. 6,866,760. Accordingly, for purposes of the present application, such polymer-dispersed electrophoretic media are regarded as sub-species of encapsulated electrophoretic media.

A related type of electrophoretic display is a so-called “microcell electrophoretic display”. In a microcell electrophoretic display, the charged particles and the fluid are not encapsulated within microcapsules but instead are retained within a plurality of cavities formed within a carrier medium, typically a polymeric film. See, for example, U.S. Pat. Nos. 6,672,921 and 6,788,449, both assigned to Sipix Imaging, Inc.

Although electrophoretic media are often opaque (since, for example, in many electrophoretic media, the particles substantially block transmission of visible light through the display) and operate in a reflective mode, many electrophoretic displays can be made to operate in a so-called “shutter mode” in which one display state is substantially opaque and one is light-transmissive. See, for example, the aforementioned U.S. Pat. Nos. 6,130,774 and 6,172,798, and U.S. Pat. Nos. 5,872,552; 6,144,361; 6,271,823; 6,225,971; and 6,184,856. Dielectrophoretic displays, which are similar to electrophoretic displays but rely upon variations in electric field strength, can operate in a similar mode; see U.S. Pat. No. 4,418,346. Other types of electro-optic displays may also be capable of operating in shutter mode.

An encapsulated or microcell electrophoretic display typically does not suffer from the clustering and settling failure mode of traditional electrophoretic devices and provides further advantages, such as the ability to print or coat the display on a wide variety of flexible and rigid substrates. (Use of the word “printing” is intended to include all forms of printing and coating, including, but without limitation: pre-metered coatings such as patch die coating, slot or extrusion coating, slide or cascade coating, curtain coating; roll coating such as knife over roll coating, forward and reverse roll coating; gravure coating; dip coating; spray coating; meniscus coating; spin coating; brush coating; air knife coating; silk screen printing processes; electrostatic printing processes; thermal printing processes; ink jet printing processes; electrophoretic deposition; and other similar techniques.) Thus, the resulting display can be flexible. Further, because the display medium can be printed (using a variety of methods), the display itself can be made inexpensively.

As noted above, electrophoretic media require the presence of a fluid. In most prior art electrophoretic media, this fluid is a liquid, but electrophoretic media can be produced using gaseous fluids; see, for example, Kitamura, T., et al., “Electrical toner movement for electronic paper-like display”, IDW Japan, 2001, Paper HCS1-1, and Yamaguchi, Y., et al., “Toner display using insulative particles charged triboelectrically”, IDW Japan, 2001, Paper AMD4-4). See also U.S. Patent Publication No. 2005/0001810; European Patent Applications 1,462,847; 1,482,354; 1,484,635; 1,500,971; 1,501,194; 1,536,271; 1,542,067; 1,577,702; 1,577,703; and 1,598,694; and International Applications WO 2004/090626; WO 2004/079442; and WO 2004/001498. Such gas-based electrophoretic media appear to be susceptible to the same types of problems due to particle settling as liquid-based electrophoretic media, when the media are used in an orientation which permits such settling, for example in a sign where the medium is disposed in a vertical plane. Indeed, particle settling appears to be a more serious problem in gas-based electrophoretic media than in liquid-based ones, since the lower viscosity of gaseous suspending fluids as compared with liquid ones allows more rapid settling of the electrophoretic particles.

The use of gaseous fluids instead of liquids in electrophoretic media does provide certain advantages. For example, since the rate at which an electrophoretic can switch between its extreme optical states is a function of the viscosity of the fluid, the use of a lower viscosity gas in place of a liquid may provide a substantial increase in switching speed, thus potentially enabling displays capable of displaying video. However, the use of gaseous fluids is attended by a number of problems, and the present invention seeks to overcome or alleviate these problems.

The aforementioned U.S. Pat. No. 7,230,751 describes various improvements in gas-based electrophoretic displays, including, inter alia:
(a) a gas-based display having at least one wall in contact with the gas and having a volume resistivity in the range of about 10⁷ to about 10¹¹ ohm cm (a “controlled resistivity wall display”);
(b) a method of charging particles in such a display, the display comprising a plurality of a first type of particle capable of being triboelectrically charged, a plurality of a second type of particle having a polarizability greater than that of the first type of particle, and a gas, the first and second types of particles and the gas being enclosed between the substrates, the method comprising applying a non-uniform electric field, thereby causing dielectrophoretic movement of the second type of particles and consequent triboelectric charging of the first type of particles (the “dielectrophoretic tribocharging method”);
(c) a gas-based display comprising a plurality of a first type of particle (electrophoretic particle) and a gas enclosed between a pair of substrates, and means for applying an electric field across the substrates so as to cause the first type of particles to move between the substrates, the display further comprising a plurality of a second type of particle (carrier particle) effective to increase triboelectric charging of the first type of particles (a “carrier particles display”);
(d) a display comprising a plurality of particles and a gas enclosed between a pair of substrates, and means for applying an electric field across the substrates so as to cause the particles to move between the substrates, wherein the gas is able to accept electrons from, or donate electrons to, the particles (an “electron accepting/donating gas display” or “EADG display”);
(e) an electrophoretic display comprising cell walls defining a plurality of cavities between a pair of substrates, a plurality of particles and a gas enclosed within the cavities, and means for applying an electric field across the substrates and arranged to drive the particles to a first optical state, in which at least some of the particles lie adjacent a viewing surface, and to drive the particles to a second optical state, in which the particles are disposed adjacent the cell walls so that the light can pass through the cavities (a “lateral movement display”);
(f) a display comprising a plurality of particles and a gas enclosed between a pair of substrates, and means for applying an electric field across the substrates, the particles comprising a plurality of a first type of particle capable of being charged with a charge of a first polarity, and a plurality of a second type of particle capable of being charged with a charge of a second polarity opposite to the first polarity, the charge on the second type of particle being smaller in magnitude than the charge on the first type of particle, the first and second types of particles having substantially the same optical characteristic (a “diluent particles display”);
(g) a display comprising a plurality of particles and a gas enclosed between a pair substrates, and means for applying an electric field across the substrates, the display comprising a plurality of pixels and the means for applying an electric field comprising at least one electrode having a surface covered by an insulating coating, the thickness of the insulating coating varying within one pixel (a “variable thickness coated electrode display”); and
(h) a display comprising a plurality of particles and a gas enclosed between a pair of substrates, and means for applying an electric field across the substrates, the display comprising at least one electrode having a surface covered by an coating which is insulating at low electric fields but conductive at high electric fields (a “variable conductivity coated electrode display”).

The present invention relates to additional improvements in gas-based electrophoretic displays. More specifically, the present invention is directed to such improvements intended to deal with the problem, discussed at length in the aforementioned U.S. Pat. No. 7,230,751, that gas-based displays may be especially susceptible to effects that reduce the mobility of the electrophoretic particles over time. These mobility-reducing effects may include redistribution of charge within the stationary portions of the display, such as cell walls, or leakage of charge from the electrophoretic particles.

These mobility-reducing effects may, in some cases, be counteracted by switching the display. For example, the charges on the electrophoretic particles may be increased by triboelectric interactions between the particles and another species of particle within the display, or by triboelectric interactions between the particles and other components of the display, for example cell walls. The present invention provides for adjustment of the drive scheme of a gas-based display to take account of factors such as the age of the display and the “dwell time”, i.e., the time since a particular pixel of the display has been changed.

### SUMMARY OF INVENTION

Accordingly, in one aspect this invention provides an electrophoretic display comprising a pair of facing substrates at least one of which is transparent, a plurality of particles and a gas enclosed between the substrates, and means for applying an electric field across the substrates so as to cause the particles to move between the substrates thereby changing the display between at least two different optical states, wherein, for at least one transition between optical states, the means for applying an electric field is arranged to increase the impulse applied to the display with increasing time since a reference time. (The term “impulse” is used herein in its conventional meaning in the imaging art of the integral of voltage with respect to time.) This type of display may hereinafter be called the “increasing impulse” display of the present invention.

This invention also provides a corresponding method for driving a gas-based electrophoretic display. Thus, this invention provides a method for driving an electrophoretic display, the method comprising:
providing an electrophoretic display comprising a pair of facing substrates at least one of which is transparent, a plurality of particles and a gas enclosed between the substrates, and means for applying an electric field across the substrates so as to cause the particles to move between the substrates thereby changing the display between at least two different optical states;
determining the period since a reference time; and
applying by means of the electric field applying means, a drive pulse effective to cause at least one pixel of the display to change from one optical state to a different optical state, the impulse of the drive pulse being dependent upon the determined period and increasing with increase of the determined period.

In the increasing impulse display and method of the present invention, the reference time used may, for example, any of the following:
(a) the time at which the display was manufactured or first placed in service (or, in the case of displays comprising multiple panels which can be replaced individually, the time at which the relevant panel was manufactured or first placed in service);
(b) the time at which a non-zero voltage was last applied to the relevant pixel of the display;
(c) in the case of a display which exhibits a threshold, the time at which a voltage greater than the threshold was last applied to the relevant pixel of the display; and
(d) the time at which the relevant pixel of the display was last switched between a predefined sub-set of optical states (for example, the time at which a pixel capable of white and black optical states and at least one intervening gray state, last underwent a transition between its extreme optical states (i.e., a black-to-white or white-to-black transition), as opposed to a transition to or from one of the intervening gray levels).

Since the impulse applied to the display in the increasing impulse display and method of the present invention is the integral of the applied voltage with respect to time, increase of this impulse may be effected in various ways. For example, the maximum voltage applied to the display may be increased with increasing time since the reference time (i.e., increasing determined period). Alternatively, the average voltage applied to the display may be increased with increasing time since the reference time. Another possibility, which may be employed with drivers which are only capable of applying one or a limited number of voltages of a given polarity to the display, is to increase the length of the drive pulse with increasing time since the reference time.

In the case of electrophoretic displays which have a threshold (i.e., the display will not change optical state unless a field exceeding a minimum value is applied), increasing the impulse applied to the display may be effected by increasing the super-threshold impulse, where the super-threshold impulse is defined as the integral of the applied voltage less the threshold voltage with respect to time, subject to the proviso that for any period when the applied voltage is equal to or less than the threshold voltage, the integral is taken as zero.

In the increasing impulse display and method of the present invention, the increase in impulse with time since the reference time (determined period) should be monotonic, in the sense that if a second determined period is greater than the first determined period, the impulse applied at the second determined period will be equal to or greater than the impulse applied at the first determined period. As discussed in more detail below, the increase in impulse with determined period may be stepwise; for example, the increasing impulse method might be effected by using a first impulse value at all determined times from 0 to (say) 30 seconds, a second, larger impulse value at all determined times from 30 seconds to 2 minutes, and a third, still larger impulse value at all determined times over 2 minutes.

In another aspect, this invention provides an electrophoretic display and method which are generally similar to the increasing impulse display and method of the present invention, except that the means for applying an electric field is arranged to increase the impulse applied to the display with increasing number of switches (i.e., increasing number of images written on the display) since a reference point.

Accordingly, this invention provides an electrophoretic display comprising a pair of facing substrates at least one of which is transparent, a plurality of particles and a gas enclosed between the substrates, and means for applying an electric field across the substrates so as to cause the particles to move between the substrates thereby changing the display between at least two different optical states, wherein, for at least one transition between optical states, the means for applying an electric field is arranged to increase the impulse applied to the display with increasing number of images written on the display since a reference time. This type of display may hereinafter be called the “increasing switch count” display of the present invention.

This invention also provides a method for driving an electrophoretic display, the method comprising:
providing an electrophoretic display comprising a pair of facing substrates at least one of which is transparent, a plurality of particles and a gas enclosed between the substrates, and means for applying an electric field across the substrates so as to cause the particles to move between the substrates thereby changing the display between at least two different optical states;
determining the number of images written on the display since a reference time; and
applying by means of the electric field applying means, a drive pulse effective to cause at least one pixel of the display to change from one optical state to a different optical state, the impulse of the drive pulse being dependent upon the determined number of images and increasing with increase of the determined number of images.

In the increasing switch count display and method of the present invention, the reference time used may, for example, the time at which the display was manufactured or first placed in service (or, in the case of displays comprising multiple panels which can be replaced individually, the time at which the relevant panel was manufactured or first placed in service).

Since the impulse applied to the display in the increasing switch count display and method of the present invention is the integral of the applied voltage with respect to time, increase of this impulse may be effected in various ways. For example, the maximum voltage applied to the display may be increased with increasing switch count since the reference time. Alternatively, the average voltage applied to the display may be increased with increasing switch count since the reference time. Another possibility, which may be employed with drivers which are only capable of applying one or a limited number of voltages of a given polarity to the display, is to increase the length of the drive pulse with increasing switch count since the reference time.

In the case of electrophoretic displays which have a threshold (i.e., the display will not change optical state unless a field exceeding a minimum value is applied), increasing the impulse applied to the display may be effected by increasing the super-threshold impulse, where the super-threshold impulse is defined as the integral of the applied voltage less the threshold voltage with respect to time, subject to the proviso that for any period when the applied voltage is equal to or less than the threshold voltage, the integral is taken as zero.

In the increasing switch display and method of the present invention, the increase in impulse with switch count since the reference time should be monotonic, in the sense that if a second switch is greater than the first, the impulse applied at the second switch count will be equal to or greater than the impulse applied at the first. As discussed in more detail below, the increase in impulse with switch count may be stepwise; for example, the increasing switch method might be effected by using a first impulse value at all switch counts from 0 to (say) 30 switches, a second, larger impulse value at all switches from 30 to 120 switches, and a third, still larger impulse value at all switch counts over 120 switches.

In another aspect, this invention provides a display and method which uses alternating current (AC) pulses to reduce or eliminate the aforementioned problems in gas-based displays. More specifically, this invention provides an electrophoretic display comprising a pair of facing substrates at least one of which is transparent, a plurality of particles and a gas enclosed between the substrates, and means for applying an electric field across the substrates so as to cause the particles to move between the substrates thereby changing the display between at least two different optical states, wherein, for at least one transition between optical states, the means for applying an electric field is arranged to apply to the display at least one alternating current pulse having a frequency at least twice the reciprocal of the switching time of the display, wherein at least one of the duration and amplitude of the alternating current pulse is increased with increasing time since a reference time. This type of display may hereinafter be called the “AC pulse” display of the present invention.

For purposes of this application, the switching time of a display (or, more accurately, of any specific pixel thereof) is defined as the time required for the display or pixel to complete 90 per cent of the change in contrast ratio between its two extreme optical states. Thus, for example, if the switching time of a pixel is 500 milliseconds, the AC pulse must have a frequency of at least 4 Hz; if the switching time is 100 milliseconds, the AC pulse must have a frequency of at least 20 Hz.

This invention also provides a corresponding method for driving a gas-based electrophoretic display. Thus, this invention provides a method for driving an electrophoretic display, the method comprising:
providing an electrophoretic display comprising a pair of facing substrates at least one of which is transparent, a plurality of particles and a gas enclosed between the substrates, and means for applying an electric field across the substrates so as to cause the particles to move between the substrates thereby changing the display between at least two different optical states;
determining the period since a reference time; and
applying by means of the electric field applying means, at least one alternating current pulse having a frequency at least twice the reciprocal of the switching time of the display, wherein at least one of the duration and amplitude of the alternating current pulse is increased with increasing determined period.

In the AC pulse display and method of the present invention, the AC pulse or pulses may be accompanied by one or more DC pulses to effect a desired transition between optical states of the relevant pixel of the display. The AC and DC pulses may be arranged in any order, and there may be multiple pulses of both types. However, it may be advantageous for the AC pulses to be applied at the beginning of the waveform used for the transition, since the AC pulses tend to restore the electrophoretic particles to a relatively standard state and reduce the effects of the prior history of the particles.

In the AC pulse display and method of the present invention, the reference time used may be any of those described above. Thus, the reference time used may, for example, any of the following:
(a) the time at which the display was manufactured or first placed in service (or, in the case of displays comprising multiple panels which can be replaced individually, the time at which the relevant panel was manufactured or first placed in service);
(b) the time at which a non-zero voltage was last applied to the relevant pixel of the display;
(c) in the case of a display which exhibits a threshold, the time at which a voltage greater than the threshold was last applied to the relevant pixel of the display; and
(d) the time at which the relevant pixel of the display was last switched between a predefined sub-set of optical states (for example, the time at which a pixel capable of white and black optical states and at least one intervening gray state, last underwent a transition between its extreme optical states (i.e., a black-to-white or white-to-black transition), as opposed to a transition to or from one of the intervening gray levels).

In the AC pulse display and method of the present invention, the increase in duration or amplitude with increased determined time may be monotonic. The increase may be stepwise.

The displays of the present invention may be used in any application in which prior art electrophoretic displays have been used. Thus, for example, the present displays may be used in electronic book readers, portable computers, tablet computers, cellular telephones, smart cards, signs, watches, shelf labels and flash drives.

### BRIEF DESCRIPTION OF DRAWINGS

FIG. 1 of the accompanying drawings illustrates a first type of transition of an electrophoretic medium which can be modified in accordance with the present invention.

FIGS. 2A and 2b illustrate the transitions undergone by two separate pixels of an electrophoretic medium in a second type of transition which can be modified in accordance with the present invention.

FIG. 3 illustrates a preferred waveform for driving electrophoretic media and capable of being modified in accordance with the present invention.

### DETAILED DESCRIPTION

As will be apparent from the preceding discussion, the present invention relates to gas-based electrophoretic displays, and methods for driving such displays, in which the drive impulse or the length or amplitude of AC pulses, of the waveform used for a specific transition, is increased to compensate for various time dependent effects, including aging of the display and the dwell time since the display, or a specific pixel thereof, has been rewritten, or the number of times the display or pixel has been rewritten. Although the increased impulse, increasing switch count and AC pulse displays and methods of the present invention have been described separately above, it will be appreciated that, in practice, a single display might make use of multiple aspects of the present invention; for example, an increased impulse method could be used to compensate for aging of the display and the AC pulse method to compensate for dwell time effects. Alternatively or in addition, one or more basic methods of the invention could be used in multiple ways at the same time. For example, one could in the same display use a “double” increased impulse method which tracks both the time since the display was placed in service and the time since each pixel was last switched, and which adjusts the impulse for a specific transition dependent on both these times.

The adjustment of the impulse and AC pulses required in the present displays and methods may be effected using any of the techniques described in the aforementioned MEDEOD applications. All except the first two of these MEDEOD applications describe methods for driving electro-optic displays in which a lookup table is provided setting out one or more waveforms to be used for each possible transition between optical states of a display, and the actual waveform to be used is selected based upon at least the initial and final states of each transition. The lookup table may store more than one waveform for a specific transition and the drive method may select one of the waveforms based upon one or more previous optical states of the pixel being driven, or an environmental parameter, for example temperature or relative humidity. Alternatively, the drive method may extract a base waveform from the lookup table and apply to this base waveform a correction based upon one or more environmental or other parameters.

In particular, the aforementioned 2005/0179642 describes a drive method in which a parameter called: “remnant voltage” is tracked and used to adjust drive waveforms. This publication describes a method in which a single remnant voltage and time stamp is stored for each pixel of a display and used to adjust the drive waveform. As will readily be apparent to those skilled in driving electro-optic displays, this method can readily be modified to carry out the methods of the present invention, with the stored remnant voltage for each pixel being replaced by a value representing the dwell time for the pixel. If desired, a single register could be used to store the age of the entire display (or that of a relevant part thereof). The stored values could then be used to vary waveform impulse or AC pulses in a manner directly analogous to those described in the aforementioned 2005/0179642.

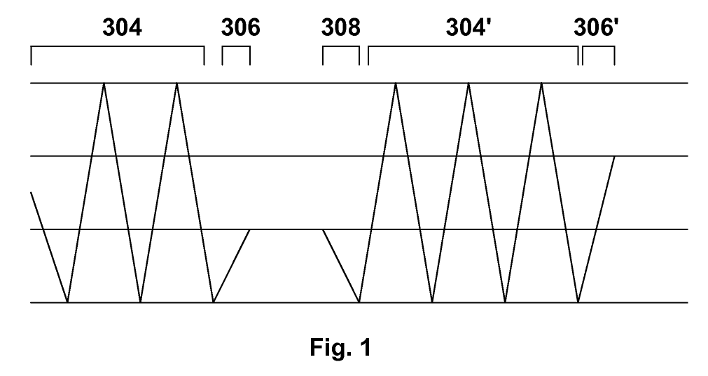

Other drive waveforms disclosed in the MEDEOD applications can be varied in a similar manner. For example, FIG. 1 of the accompanying drawings, which reproduces FIG. 9 of the aforementioned U.S. Pat. No. 7,012,600 (to which the reader is referred for a fuller explanation of the reasons for the use of this type of transition), shows schematically the variation of gray level with time of one pixel of an electrophoretic display undergoing a series of transitions. At the beginning of series, the pixel is in some arbitrary gray state. During a “reset” step 304, the pixel is driven alternately to three black states and two intervening white states, ending in its black state (level 0). The pixel then, at 306, has applied to it an impulse sufficient to drive it to the appropriate gray level for a first image, this gray level being assumed to be level 1. The pixel remains at this level for some time during which the same image is displayed; the length of this display period is greatly reduced in FIG. 1 for ease of illustration. At some point, a new image needs to be written, and at this point, the pixel has applied to it an impulse sufficient to drive it back to black (level 0) in erase step 308. The pixel is then subjected, in a second reset step designated 304′, to six reset pulses, alternately white and black, so that at the end of this reset step 304′, the pixel has returned to a black state. Finally, in a second writing step designated 306′, the pixel is written with the appropriate gray level for a second image, assumed to be level 2.

The impulses applied to the pixel in the writing steps 306 and 306′ and in the erase step 308 may be adjusted by the methods of the present invention to allow for the effects of aging of the electrophoretic medium, number of switches undergone by the medium or the length of time between successive switches. It will typically not be necessary to adjust the reset pulses 304 and 304′ since such reset pulses typically apply an impulse which is greater than the minimum needed to achieve the extreme optical state desired, so that minor variations in the behavior of the electrophoretic medium due to aging or other factors do not affect the ability of the medium to reach the extreme optical state desired after a reset pulse. However, the reset pulses can of course if desired be adjusted by the methods of the present invention.

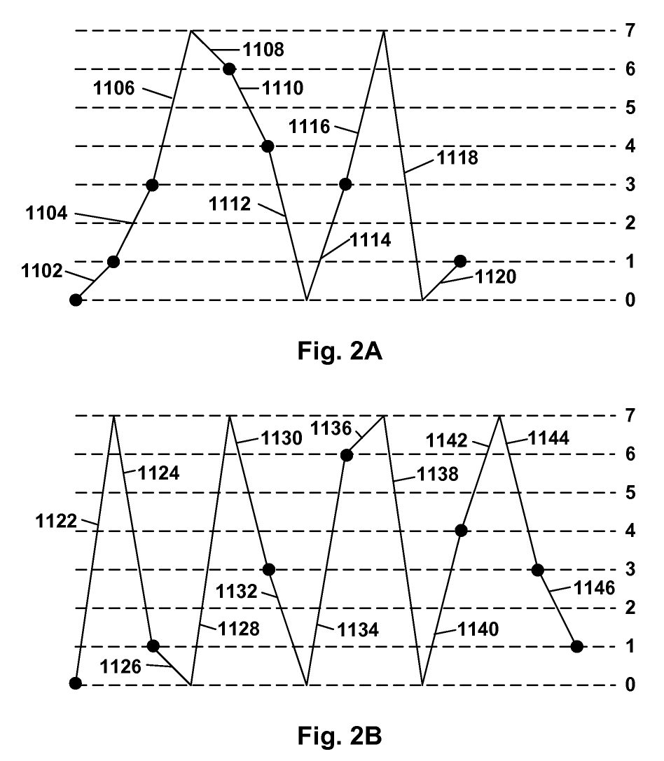

FIGS. 2A and 2B of the accompanying drawings, which reproduce FIGS. 11A and 11B respectively of the aforementioned U.S. Pat. No. 7,012,600 (to which the reader is referred for a fuller explanation of the reasons for the use of this type of transition), show schematically the variation of gray level with time of two different pixels of an electrophoretic display undergoing a series of transitions. In this scheme, the pixels are divided into two groups, with the first (or “even”) group following the drive scheme shown in FIG. 2A and the second (“odd”) group following the drive scheme shown in FIG. 2B. Also in this scheme, all the gray levels intermediate black and white are divided into a first group of contiguous dark gray levels adjacent the black level, and a second group of contiguous light gray levels adjacent the white level, this division being the same for both groups of pixels. Desirably but not essentially, there are the same number of gray levels in these two groups; if there are an odd number of gray levels, the central level may be arbitrarily assigned to either group. For ease of illustration, FIGS. 2A and 2B show this drive scheme applied to an eight-level gray scale display, the levels being designated 0 (black) to 7 (white); gray levels 1, 2 and 3 are dark gray levels and gray levels 4, 5 and 6 are light gray levels.

In the drive scheme of FIGS. 2A and 2B, gray to gray transitions are handled according to the following rules:
(a) in the first, even group of pixels, in a transition to a dark gray level, the last pulse applied is always a white-going pulse (i.e., a pulse having a polarity which tends to drive the pixel from its black state to its white state), whereas in a transition to a light gray level, the last pulse applied is always a black-going pulse;
(b) in the second, odd group of pixels, in a transition to a dark gray level, the last pulse applied is always a black-going pulse, whereas in a transition to a light gray level, the last pulse applied is always a white-going pulse;
(c) in all cases, a black-going pulse may only succeed a white-going pulse after a white state has been attained, and a white-going pulse may only succeed a black-going pulse after a black state has been attained; and
(d) even pixels may not be driven from a dark gray level to black by a single black-going pulse nor odd pixels from a light gray level to white using a single white-going pulse.

### (Obviously, in both cases, a white state can only be achieved using a final white-going pulse and a black state can only be achieved using a final black-going pulse.)

The application of these rules allows each gray to gray transition to be effected using a maximum of three successive pulses. For example, FIG. 2A shows an even pixel undergoing a transition from black (level 0) to gray level 1. This is achieved with a single white-going pulse (shown of course with a positive gradient in FIG. 2A) designated 1102. Next, the pixel is driven to gray level 3. Since gray level 3 is a dark gray level, according to rule (a) it must be reached by a white-going pulse, and the level 1/level 3 transition can thus be handled by a single white-going pulse 1104, which has an impulse different from that of pulse 1102.

The pixel is now driven to gray level 6. Since this is a light gray level, it must, by rule (a) be reached by a black-going pulse. Accordingly, application of rules (a) and (c) requires that this level 3/level 6 transition be effected by a two-pulse sequence, namely a first white-going pulse 1106, which drives the pixel white (level 7), followed by a second black-going pulse 1108, which drives the pixel from level 7 to the desired level 6.

The pixel is next driven to gray level 4. Since this is a light gray level, by an argument exactly similar to that employed for the level 1/level 3 transition discussed earlier, the level 6/level 4 transition is effected by a single black-going pulse 1110. The next transition is to level 3. Since this is a dark gray level, by an argument exactly similar to that employed for the level 3/level 6 transition discussed earlier, the level 4/level 3 transition is handled by a two-pulse sequence, namely a first black-going pulse 1112, which drives the pixel black (level 0), followed by a second white-going pulse 1114, which drives the pixels from level 0 to the desired level 3.

The final transition shown in FIG. 2A is from level 3 to level 1. Since level 1 is a dark gray level, it must, according to rule (a) be approached by a white-going pulse. Accordingly, applying rules (a) and (c), the level 3/level 1 transition must be handled by a three-pulse sequence comprising a first white-going pulse 1116, which drives the pixel white (level 7), a second black-going pulse 1118, which drives the pixel black (level 0), and a third white-going pulse 1120, which drives the pixel from black to the desired level 1 state.

FIG. 2B shows an odd pixel effecting the same 0-1-3-6-4-3-1 sequence of gray states as the even pixel in FIG. 2A. It will be seen, however, that the pulse sequences employed are very different. Rule (b) requires that level 1, a dark gray level, be approached by a black-going pulse. Hence, the 0-1 transition is effected by a first white-going pulse 1122, which drives the pixel white (level 7), followed by a black-going pulse 1124, which drives the pixel from level 7 to the desired level 1. The 1-3 transition requires a three-pulse sequence, a first black-going pulse 1126, which drives the pixel black (level 0), a second white-going pulse 1128, which drives the pixel white (level 7), and a third black-going pulse 1130, which drives the pixel from level 7 to the desired level 3. The next transition is to level 6 is a light gray level, which according to rule (b) is approached by a white-going pulse, the level 3/level 6 transition is effected by a two-pulse sequence comprising a black-going pulse 1132, which drives the pixel black (level 0), and a white-going pulse 1134, which drives the pixel to the desired level 6. The level 6/level 4 transition is effected by a three-pulse sequence, namely a white-going pulse 1136, which drives the pixel white (level 7), a black-going pulse 1138, which drives the pixel black (level 0) and a white-going pulse 1140, which drives the pixel to the desired level 4. The level 4/level transition 3 transition is effected by a two-pulse sequence comprising a white-going pulse 1142, which drives the pixel white (level 7), followed by a black-going pulse 1144, which drives the pixel to the desired level 3. Finally, the level 3/level 1 transition is effected by a single black-going pulse 1146.

It will be seen from FIGS. 2A and 2B that this drive scheme ensures that each pixel follows a “sawtooth” pattern in which the pixel travels from black to white without change of direction (although obviously the pixel may rest at any intermediate gray level for a short or long period), and thereafter travels from white to black without change of direction. Thus, rules (c) and (d) above may be replaced by a single rule (e) as follows:
(e) once a pixel has been driven from one extreme optical state (i.e., white or black) towards the opposed extreme optical state by a pulse of one polarity, the pixel may not receive a pulse of the opposed polarity until it has reached the aforesaid opposed extreme optical state.

Thus, this drive scheme ensures that a pixel can only undergo, at most, a number of transitions equal to (N-1)/2 transitions, where N is the number of gray levels, before being driven to one extreme optical state; this prevents slight errors in individual transitions (caused, for example, by unavoidable minor fluctuations in voltages applied by drivers) accumulating indefinitely to the point where serious distortion of a gray scale image is apparent to an observer. Furthermore, this drive scheme is designed so that even and odd pixels always approach a given intermediate gray level from opposed directions, i.e., the final pulse of the sequence is white-going in one case and black-going in the other. If a substantial area of the display, containing substantially equal numbers of even and odd pixels, is being written to a single gray level, this “opposed directions” feature minimizes flashing of the area.

In the drive scheme shown in FIGS. 2A and 2B, the impulses applied to some or all of the various sub-transitions (for example the three sub-transitions 1116, 1118, 1120) may be adjusted by the methods of the present invention to allow for the effects of aging of the electrophoretic medium, number of switches undergone by the medium or the length of time between successive switches.

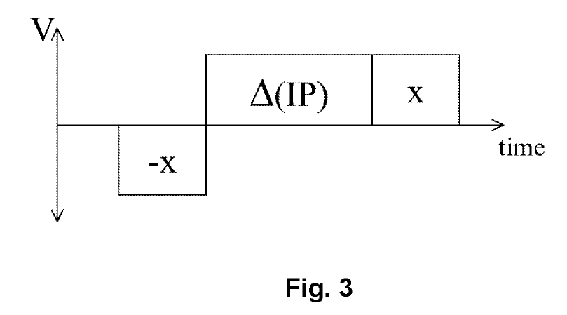

Finally, FIG. 3, which reproduces FIG. 12 of the aforementioned 2005/0024353, shows one preferred waveform used for driving electrophoretic media. The waveform has three components, represented symbolically as:

−x, Δ(IP), +x,

where −x and +x are two pulses of equal but opposite impulses and Δ(IP) represents the difference in impulse potential between the initial and final states of the relevant transition, as explained more fully in the aforementioned 2005/0024353. When this preferred type of waveform is modified in accordance with the present invention, it is typically only necessary to vary the value of Δ(IP). Since the −x and +x pulses are of equal but opposite impulses and thus largely cancel each other out, any small deviations between the values of the −x and +x pulses actually applied and the corresponding “ideal” values corrected for factors such as the aging of the electrophoretic medium are unlikely to have any significant effect on the electro-optic performance of the medium.

It will be apparent to those skilled in the art that numerous changes and modifications can be made in the specific embodiments of the invention described above without departing from the scope of the invention. Accordingly, the whole of the foregoing description is to be interpreted in an illustrative and not in a limitative sense.

1. An electrophoretic display comprising a pair of facing substrates at least one of which is transparent, a plurality of particles and a gas enclosed between the substrates, and means for applying an electric field across the substrates so as to cause the particles to move between the substrates thereby changing the display between at least two different optical states, wherein, for at least one transition between optical states, the means for applying an electric field is arranged to increase the impulse applied to the display with increasing time since a reference time.

2. An electrophoretic display according to claim 1 wherein the reference time is the time at which the display was manufactured or first placed in service.

3. An electrophoretic display according to claim 2 wherein the display comprises multiple panels which can be replaced individually, and the reference time for any specific panel is the time at which the specific panel was manufactured or first placed in service.

4. An electrophoretic display according to claim 1 wherein the reference time for any specific pixel of the display is the time at which a non-zero voltage was last applied to the specific pixel.

5. An electrophoretic display according to claim 1 wherein the display exhibits a threshold, and the reference time for any specific pixel of the display is the time at which a voltage greater than the threshold was last applied to the specific pixel.

6. An electrophoretic display according to claim 1 wherein the reference time for any specific pixel of the display is the time at which the relevant pixel of the display was last switched between a predefined sub-set of its optical states.

7. An electrophoretic display according to claim 6 wherein each pixel of the display is capable of two extreme optical states and at least one intermediate optical state, and the predefined sub-set comprises the two extreme optical states.

8. An electrophoretic display according to claim 1 wherein the increase in the impulse applied to the display with increasing time is monotonic.

9. An electrophoretic display according to claim 1 wherein the increase in the impulse applied to the display with increasing time is stepwise.

10. A method for driving an electrophoretic display, the method comprising:
providing an electrophoretic display comprising a pair of facing substrates at least one of which is transparent, a plurality of particles and a gas enclosed between the substrates, and means for applying an electric field across the substrates so as to cause the particles to move between the substrates thereby changing the display between at least two different optical states;
determining the period since a reference time; and
applying by means of the electric field applying means, a drive pulse effective to cause at least one pixel of the display to change from one optical state to a different optical state, the impulse of the drive pulse being dependent upon the determined period and increasing with increase of the determined period.

11. A method according to claim 10 wherein the reference time is the time at which the display was manufactured or first placed in service.

12. A method according to claim 11 wherein the display comprises multiple panels which can be replaced individually, and the reference time for any specific panel is the time at which the specific panel was manufactured or first placed in service.

13. A method according to claim 10 wherein the reference time for any specific pixel of the display is the time at which a non-zero voltage was last applied to the specific pixel.

14. A method according to claim 10 wherein the display exhibits a threshold, and the reference time for any specific pixel of the display is the time at which a voltage greater than the threshold was last applied to the specific pixel.

15. A method according to claim 10 wherein the reference time for any specific pixel of the display is the time at which the relevant pixel of the display was last switched between a predefined sub-set of its optical states.

16. A method according to claim 15 wherein each pixel of the display is capable of two extreme optical states and at least one intermediate optical state, and the predefined sub-set comprises the two extreme optical states.

17. A method according to claim 10 wherein the increase in the impulse applied to the display with increasing time is monotonic.

18. A method according to claim 10 wherein the increase in the impulse applied to the display with increasing time is stepwise.

19. An electrophoretic display comprising a pair of facing substrates at least one of which is transparent, a plurality of particles and a gas enclosed between the substrates, and means for applying an electric field across the substrates so as to cause the particles to move between the substrates thereby changing the display between at least two different optical states, wherein, for at least one transition between optical states, the means for applying an electric field is arranged to increase the impulse applied to the display with increasing number of images written on the display since a reference time.

20. A method for driving an electrophoretic display, the method comprising:
providing an electrophoretic display comprising a pair of facing substrates at least one of which is transparent, a plurality of particles and a gas enclosed between the substrates, and means for applying an electric field across the substrates so as to cause the particles to move between the substrates thereby changing the display between at least two different optical states;
determining the number of images written on the display since a reference time; and
applying by means of the electric field applying means, a drive pulse effective to cause at least one pixel of the display to change from one optical state to a different optical state, the impulse of the drive pulse being dependent upon the determined number of images and increasing with increase of the determined number of images.

21. An electrophoretic display comprising a pair of facing substrates at least one of which is transparent, a plurality of particles and a gas enclosed between the substrates, and means for applying an electric field across the substrates so as to cause the particles to move between the substrates thereby changing the display between at least two different optical states, wherein, for at least one transition between optical states, the means for applying an electric field is arranged to apply to the display at least one alternating current pulse having a frequency at least twice the reciprocal of the switching time of the display, wherein at least one of the duration and amplitude of the alternating current pulse is increased with increasing time since a reference time.

22. A method for driving an electrophoretic display, the method comprising:
providing an electrophoretic display comprising a pair of facing substrates at least one of which is transparent, a plurality of particles and a gas enclosed between the substrates, and means for applying an electric field across the substrates so as to cause the particles to move between the substrates thereby changing the display between at least two different optical states;
determining the period since a reference time; and
applying by means of the electric field applying means, at least one alternating current pulse having a frequency at least twice the reciprocal of the switching time of the display, wherein at least one of the duration and amplitude of the alternating current pulse is increased with increasing determined period.

23. An electronic book reader, portable computer, tablet computer, cellular telephone, smart card, sign, watch, shelf label or flash drive comprising a display according to claim 1.
